(19) United States
(12) Patent Application Publication
(10) Pub. No.: US 2026/0243207 A1
(43) Pub. Date: Aug. 20, 2026

(54) METHOD OF CONTROLLING INJECTION IN A HYDROGEN INTERNAL COMBUSTION ENGINE

(71) Applicant: PHINIA DELPHI LUXEMBOURG SARL, Belvaux (LU)

(72) Inventors: Mathieu DA GRACA, Chaumont sur Loire (FR); Guillaume MEISSONIER, Landes Le Gaulois (FR)

(21) Appl. No.: 19/120,444

(22) PCT Filed: Oct. 13, 2023
(86) PCT No.: PCT/EP2023/078444

§ 371 Date: Apr. 11, 2025

(30) Foreign Application Priority Data
Oct. 26, 2022 (GB) 2215857.0

(51) Int. Cl. F02D 41/00; F02D 1/02

(52) U.S. Cl. CPC F02D 41/0087; F02D 1/02; F02D 41/0027; F02D 2200/0602; F02D 2200/101

(57) ABSTRACT

A method of controlling injection in a hydrogen internal combustion engine including a plurality of cylinders, Nc, wherein injection events are performed by applying drive signals to fuel injectors in order to inject predetermined fuel quantities of hydrogen includes the steps of: determining a nominal fuel quantity Q_{C,N} to be injected in a cylinder based on torque demand; determining whether the nominal fuel quantity Q_{C,N} falls within a predetermined forbidden region, FR, of a flow characteristic of the fuel injector; whereby if the nominal fuel quantity Q_{C,N} does not fall within FR, injecting the nominal fuel quantity Q_{C,N} into the cylinder; or if the nominal fuel quantity Q_{C,N} does fall within FR, then injecting into the cylinder a fraction of the nominal fuel quantity Q_{C,N} that does not fall within FR, or skipping fuel injection in the cylinder, and distributing the remainder of the nominal fuel quantity Qc, N over one or more subsequent injection events in other cylinder(s).

### FIELD OF THE INVENTION

The present invention generally relates to fuel injection and more specifically to injection control in a hydrogen internal combustion engine.

### BACKGROUND OF THE INVENTION

Hydrogen is increasingly viewed, along with electric vehicles, as one way to slow the environmentally destructive impact of the planet's 1.2 billion vehicles, most of which burn gasoline and diesel fuel. Manufacturers of large trucks, commercial vehicles as well as passenger vehicles are currently developing hydrogen engines, i.e. where hydrogen is used as fuel instead of the usual liquid fuels.

Hydrogen engines are developed by analogy to the conventional diesel and gasoline engines. Of course, the conventional engine, in particular its components, must be adapted to take into account the specifics of hydrogen fuel, namely its combustibility, the need for enhanced sealing measures within the fuel delivery system.

In this context, fuel injectors for hydrogen injection will be based on the conventional operation principle of a fuel valve controlled by a pintle that is pulled by a solenoid actuator. Such fuel injectors have been satisfactorily used in the past, as their flow curve is typically linear, except for small fuel quantities, in the so-called ballistic region.

As is known, the non-linear behavior of the fuel injector in the ballistic region is particularly problematic when the engine is idling, causing instabilities. The conventional way to address this is to retard spark to the point of artificially degrading efficiency to achieve the needed torque with significant increased quantity.

It is an object of the present invention to provide a more robust control of fuel injection for hydrogen engines.

### SUMMARY OF THE INVENTION

The present invention relates to a method of controlling injection in a hydrogen internal combustion engine comprising a plurality of cylinders (Nc), wherein injection events are performed, in a predetermined order in the cylinders, by applying drive signals to fuel injectors in order to inject predetermined fuel quantities of hydrogen. The method comprises the steps of:
determining a nominal fuel quantity Q_{C,N} to be injected in a cylinder based on torque demand;
determining whether the nominal fuel quantity Q_{C,N} falls within a predetermined forbidden region, FR, of a flow characteristic of the fuel injector.

Based on this determination relative to the forbidden region FR, the control of fuel injection is performed as follows:
if the nominal fuel quantity Q_{C,N} does not fall within FR, injecting the nominal fuel quantity Q_{C,N} into the cylinder;
if the nominal fuel quantity Q_{C,N} does fall within FR, then injecting into the (first) cylinder a fraction of the nominal fuel quantity Q_{C,N} that does not fall within FR, or skipping fuel injection in the respective cylinder, and distributing the remainder of the nominal fuel quantity Q_{C,N} over one or more subsequent injection events in other cylinder(s).

The present invention thus proposes a method where the fuel quantity to be injected is modified in order to avoid operating the fuel injector in a predetermined operating range represented by the forbidden region.

The forbidden region FR is by definition a region wherein the fuel injector should not be operated. The forbidden region may be defined in terms of injection parameters reflecting the flow characteristics, in particular in terms of fuel quantity or pulse width (actuation duration). The forbidden region may be defined as a range of fuel quantity and/or a range of pulse widths. If desirable, the forbidden region may comprise several ranges of forbidden operating values.

In embodiments, the forbidden region(s) is dependent on fuel pressure and engine speed.

In the context of the invention, the forbidden range is determined by calibration, for example based on flow curve data that are statistically representative for a fuel injector series and/or design. In particular the forbidden range includes fuel quantity or pulse width ranges that correspond to non-linear portions of the flow curve, or to steep portions of the flow curves.

The inventive method can be easily integrated in an existing fuel control strategy, since it can be implemented at the level of the final fuel mass calculation. In that context, the nominal fuel quantity Q_{C,N} is the fuel quantity that is normally determined for each cylinder based on torque demand, and which is used as the desired quantity for actuating the injector. When Q_{C,N} is not within FR, this value Q_{C,N} is used for injection, i.e. a corresponding pulse width is determined for the injection event in the respective cylinder. This is typically the case for medium to large fuel quantities, where the injector flow behavior is largely linear.

However, in case Q_{C,N} falls within FR, the injection scheme is modified in order not to operate the in the non-linear region of the flow curves. This would typically occur for low fuel amounts.

According to the invention, the injection scheme is modified such that a fraction of the nominal fuel quantity Q_{C,N} is injected, and the non-injected fraction, referred to as “remainder”, is injected in one or more of the subsequent injection events in the other engine cylinder or cylinders.

In an engine with Nc cylinders, a fuel global mass is generally determined for an engine cycle based on torque demand. The term “engine cycle” means that the Nc cylinders will have completed their respective 4 stroke cycle. The nominal fuel quantity Q_{C,N} for injection in each cylinder may thus generally be computed as the fuel global mass divided by Nc. However, there may be other ways of determining Q_{C,N}. In the context of the invention, the amount Q_{C,N} is preferably substantially equal between cylinders, or at least the difference is not greater than 10%.

The present method is typically applied with respect to an engine cycle. Hence the comparison of Q_{C,N} to the FR is carried out in respect of the first cylinder within the engine cycle. The remainder amount is then to be injected the next cylinder (or in more than one of the following cylinders) according to the firing order.

Various options are available to determine the fraction to be injected.

In embodiments, the remainder is first determined as the amount to be added to Q_{C,N} to exceed the FR (difference between the upper value of FR and Q_{C,N}). The fraction to be injected is thus determined as the difference between Q_{C,N} and the remainder.

Alternatively, this fraction of fuel to be injected may be computed by applying a coefficient (<1), which may depend on the value Q_{C,N}. The coefficient may be determined by calibration and/or simulation.

Advantageously, the fuel fraction to be injected is computed, respectively the coefficient defined, such that the corresponding quantity does not fall within FR. In embodiments, the injection scheme can be modified to skip the injection in the respective cylinder. In such case no injection is performed in the respective cylinder, whereby the remainder corresponds to the entire quantity Q_{C,N} which is then split over one or more of the subsequent injection events in the other engine cylinders. This second option can in practice be implemented by computing a fraction of Q_{C,N} by multiplying with a coefficient equal to zero.

For applying the fraction strategy, the coefficients may be dependent on Q_{C,N}, and defined/calibrated such that the injected fraction of Q_{C,N} is outside (typically below) the forbidden range. In addition, the total amount of fuel to be injected in the next cylinder, corresponding to Q_{C,N} plus the remainder amount, should not be in the FR either (and typically above).

It should be appreciated that the inventive method, is made possible in the context of the hydrogen engine, because of its wide lambda combustion stability. Accordingly, change on injected fuel mass can be operated without mandatory change on the air flow.

Furthermore, in the present method a more accurate control of injected fuel amounts is obtained by avoiding the knee region of the flow curve, this by skipping injection or fractioning/distributing fuel amounts, instead of degrading efficiency.

The present method can advantageously be implemented using mappings depending on fuel pressure and engine speed to define the forbidden range, that define lower (Qmin1) and upper (Qmax1) bound values of the forbidden range. In embodiments, in case the nominal fuel quantity Q_{C,N} falls within FR, a remainder amount Q_{R1} is computed as the difference between the upper value (Qmax1) of FR and Q_{C,N}, and the injectable amount for the cylinder is computed as the difference: Q_{5.1}=Q_{C,N}, −QR1; whereas the amount injectable for the next cylinder is computed as Q_{C,N}+Q_{R1}.

In embodiments, in case Q_{5.1} is greater than a minimum injection threshold Qmin2 read from a map defining the minimum fuel quantity that can be injected in function of fuel pressure and engine speed, then the amount Q_{5.1} is injected. In case Q_{5.1} is smaller than the minimum injection threshold Qmin2, the injection in the respective cylinder is skipped and the nominal fuel quantity Q_{C,N} is distributed over one or more cylinders of the subsequent cylinders.

In embodiments, in case Q_{5.1}<Qmin2, then a remainder amount is computed as Q_{R2}=Q_{C,N}/Nc; and
if the amount Q5+Q_{R2} is greater than the upper value of FR, then the injector is controlled to inject the amount Q5+QR2 in the following cylinders;
else, the injection amount is skipped and the next injection event is performed with a fuel amount 2×Q_{C,N}.

### BRIEF DESCRIPTION OF THE DRAWINGS

The present invention will now be described, by way of example, with reference to the accompanying drawings, in which:

FIG. 1: is a graph illustrating the flow characteristics (quantity vs. PW) of a series of fuel injectors;

FIG. 2: is a detail of the graph (Q vs PW) of FIG. 1 in the ‘knee’region;

FIG. 3: is a graph (Q vs PW) corresponding to that of FIG. 2, on which an aspect of the inventive principle is illustrated;

FIG. 4: is a diagram showing the distribution of fuel amounts according to conventional practice;

FIG. 5: shows three diagrams illustrating embodiments of the present method.

### DETAILED DESCRIPTION OF PREFERRED EMBODIMENTS

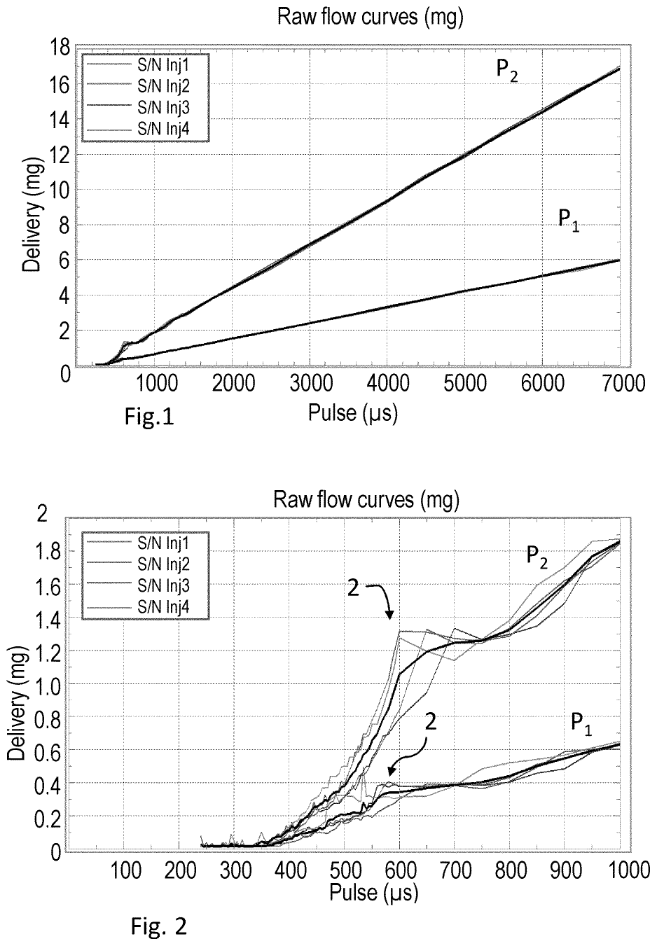

FIGS. 1 and 2 show graphs illustrating the flow characteristics of a series of fuel injectors (fuel quantity vs. time) for two different fuel pressures. The horizontal axis indicates the duration of the command pulse (pulse width, PW) applied to the injector, whereas the Y axis indicates the corresponding injected fuel quantity. These curves, which are also referred to as flow curves, are characteristic for solenoid actuated fuel injectors.

As can be seen, the injectors have a substantially linear flow characteristic (delivered fuel quantity vs. PW) at a given pressure. In the graph, two sets of four curves are shown (the thicker black line represents the average of the four traces), for two rail pressure p1 and p2, where p2>p1.

As is known, although the flow curves are generally linear, it is however not the case for the region shown in FIG. 2, which corresponds to rather small fuel quantities. Indeed, to inject small fuel amounts the pulse width is comparatively shorter than for large quantities, whereby the pintle operates in the so-called ballistic region (also referred to as “foot” of the flow curve). This causes this kind of kink or knee in the flow curves, indicated by arrow 2.

When injection is operated in this knee region, there may be significant differences in injected fuel from cylinder to cylinder, whereby scatter can be high and idle control not robust. As can be seen, there the flow curves present a steep slope and thus a high change of gradient in that area, causing e.g. unstable idle.

This is increasingly critical when the target engine power is increased as the needed higher pintle stroke injection pressure range is increased, resulting in a higher spring force and minimum actuation force that is increasing, hence a wider and steeper ballistic region overlapping with engine idle needed quantity.

Traditional methods on GDi and hydrogen engines would be to retard spark to the point of artificially degrading efficiency in order to achieve the needed torque with significantly increased quantity.

### Invention

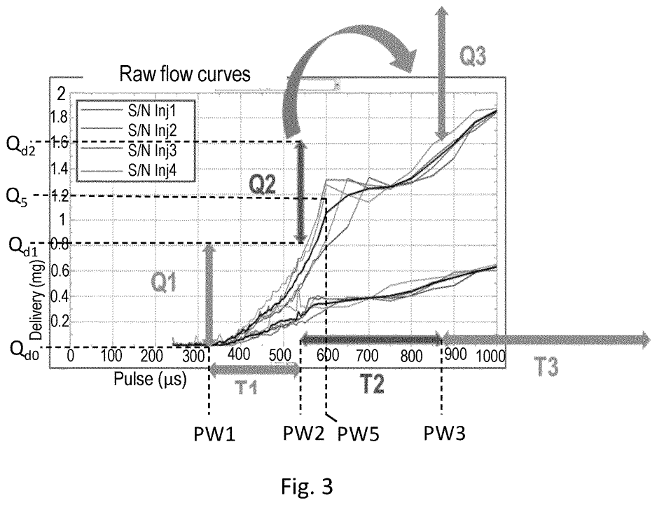

The principle of the present invention is illustrated in FIG. 3. The idea of the invention is to adapt fuel demand in order to avoid a predefined part of the flow curve.

In the exemplary case of FIG. 3, the flow curves are divided in three sections:
section T1 (pulse width PW1 to PW2), corresponding to fuel amounts Qd0 to Qd1 (section Q1)
section T2 (pulse width PW2 to PW3), corresponding to fuel amounts Qd1 to Qd2 (section Q2)
section T3 (pulse width >PW3), corresponding to fuel amounts above Qd2 (section Q3)

Here, section (T2; Q2) is the critical section of the flow curves (here given for pressure p2), with steep slope, leading to scattering behavior of injected fuel amounts. Section (T2; Q2) is, in the inventive method, defined as a so-called ‘forbidden region’, noted FR, based on the flow curves determined in the factory. Such forbidden section will be defined for a plurality of operating pressure. In the inventive method, this section (T2; Q2) of the flow curve is avoided by adapting the injected fuel quantity.

In practice, a fuel global mass Q_{G} is computed for a given engine cycle based on the torque demand. This fuel global mass is equally split between each injector/cylinder. Hence a nominal fuel amount, noted Q_{C,N} to be injected per cylinder is typically Q_{C,N}=Q_{G}/Nc, where Nc is the number of cylinders. This is part of conventional methods and will not be explained in detail. It may be noted here that the inventive concept is compatible with conventional methods in that it may be implement to come into play after the conventional fuel amount determination per fuel cylinder.

Hence, for a given injection event in a given cylinder, there is determined a nominal quantity of hydrogen Q_{C,N} to be injected in the cylinder based on torque demand.

In accordance with the present method, it is then determining whether Q_{C,N} requires operating the injector within a predetermined forbidden region, FR, of a flow characteristic of the respective fuel injector.

In the example of FIG. 3, the forbidden region FR corresponds to section (T2; Q2) of the flow curves. In practice, the forbidden region FR may be defined as a range, namely range [Qd1, Qd2], and it may be determined whether the fuel amount Q_{C,N} falls within the range [Qd1, Qd2].

If Q_{C,N} does not fall within FR, then fuel amount Q_{C,N} is injected into the respective cylinder, in the usual manner. Indeed, the amount Q_{C,N} requires activation of the injector below Qd1 or above Qd2, i.e. outside the kink region of the flow curve. If however Q_{C,N} does fall within the forbidden range FR, then the method implements a strategy where a fuel amount corresponding to only a fraction of the nominal value Q_{C,N} is injected. This fraction is however determined such that it does not fall within the FR. Since only a fraction of Q_{C,N} is injected, there is a remaining amount of fuel, which is then distributed over one or more subsequent injection events in other cylinder(s).

Another possible strategy where Q_{C,N} falls within the forbidden range FR, is to skip fuel injection in the respective cylinder, and distribute the full amount Q_{C,N} over one or more subsequent injection events.

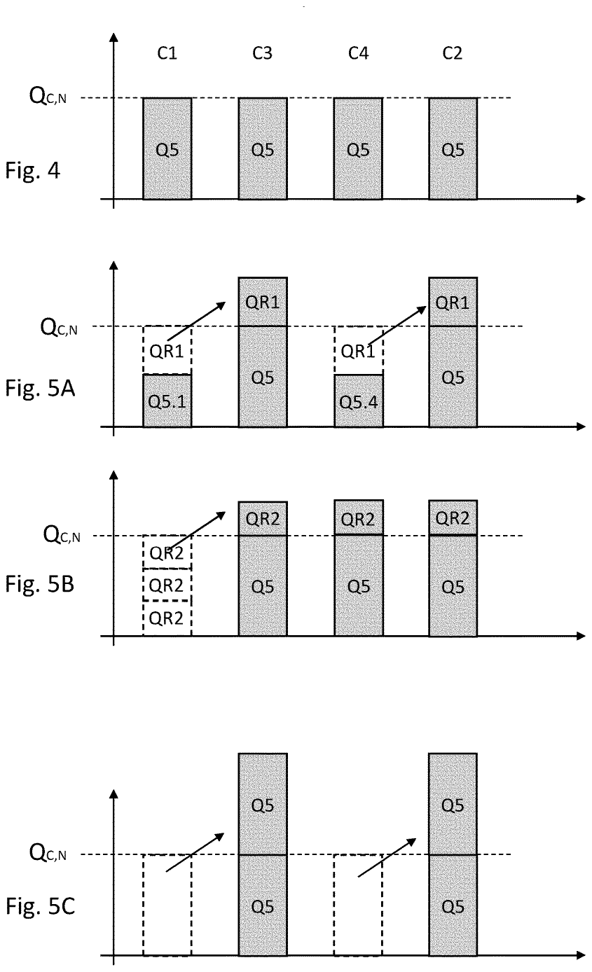

The principle of the present method will now be explained with reference to FIGS. 4 and 5.

FIG. 4 illustrates the conventional approach. The injection scheme is operated over the injection cycle, i.e. for the four engine cylinders (c1 to c4), in order to to inject the nominal amount Q_{C,N}, i.e. the injectors are actuated with a corresponding pulse width. This injection is applied in the context of the invention for Q_{C,N} amounts with sections Q1 and Q3.

Let us now suppose that, based on the current torque demand, the nominal fuel quantity to be injected per cylinder is Q5, i.e. Qc, N=Q5.

Q₅ (corresponding to PW5) is indicated in FIG. 3 and falls within the range [Qd1, Qd2], i.e. it falls within the forbidden range FR.

FIGS. 5A, B and C illustrate injection schemes according to embodiments of the present method, where it has been determined that Q_{C,N} falls within FR, as is the case for Q₅.

FIG. 5A illustrates the first scheme, where a fraction of Q_{C,N} (here we still have Q_{C,N}=Q5), noted Q_{5.1}, is injected in cylinder c1. The remainder of the fuel, i.e. the non-injected part of Q5 in c1, noted Q_{R.1}, is injected with the injection event in the next cylinder c3.

In case the amount Q_{5.1} is determined to be below Qd1, i.e. in the first section T1 of the fuel curve, and the total fuel amount Q₅+Q_{R.1} for the next cylinder (C3) is above Qd2 (hence in section T3 of the flowcurve), then the injection is performed with the so-determined amounts as illustrated in FIG. 5A.

We therefore have the following relations for this injection event in cylinder c1: Q_{C,N}=Q₅ and Q₅=Q_{5.1}+Q_{R.1} The same splitting of fuel amounts occurs for cylinders cylinder C4 and C2, where only a fraction Q_{5.4} is injected in C4 and the same remainder amount Q_{R.1} is injected in C2.

To sum up, the amounts to be injected in c1 and c4 are equal fractions noted Q5.1 and Q5.4.

The amount to be injected in c3 and c2 correspond to Q5+QR1.

FIG. 5B represents an alternative injection scheme, still with the assumption that the nominal fuel quantity determined by the ECU is Q₅, i.e. Q_{C,N}=Q₅.

According to this embodiment, in a situation where Q_{C,N} falls within FR, it decides to skip injection on respective cylinder, here the first cylinder c1. That is, no injection is performed in the respective cylinder, and the value Q_{C,N} (i.e. Q5) is distributed equally over the three other cylinders of the engine. The desired fuel amount Q_{C,N} being equal to Q₅, the remaining fuel quantity to be distributed in the other cylinders C3, C4, C2 is thus computed as Q_{R.2}=⅓*Q₅.

Each of the cylinder C3, C4, C2 will thus receive a fuel quantity corresponding to Q_{R.2}+Q₅.

The above schemes can be implemented in various way by software in the ECU or other control unit. One possible practical embodiment is disclosed in the following. 2D Mappings depending on fuel pressure and engine speed are used for defining the lower and upper bounds (corresponding to Qd1 and Qd2 in FIG. 3) of the forbidden region FR. In this example the maps that define fuel quantities corresponding to the forbidden region and are noted:
MAP-Qmin1(Pressure, RPM) for the lower range values; and
MAP-Qmax1(Pressure, RPM) for the upper range values.

Let us suppose that the fuel management system determines that the nominal fuel quantity Q_{C,N} is Q5, as discussed above.

Then according to an embodiment of the method, Q5 is compared to Qmin1 and Qmax1, which are read from tables MAP-Qmin1 and MAP-Qmax1 for the corresponding pressure and engine speed.

In the example, Q5 is in the forbidden region, i.e. Qmin1<Q5<Qmax1.

In such case, the system will compute a split of the first injection as follows:
Q_{R1}=Qmax1−Q5
whereby adding Q_{R1} to Q5 will give a fuel quantity that exceed Qmax1, i.e. just above the knee region.

And then the fuel amount for the cylinder 1 will be:
Q5.1=Q5−Q_{R1}

The same quantity is used for cylinder 4 Q5.4=Q5.1.

We will then we have for cylinder 3 the fuel quantity Q5+Q_{R1} and the same quantity for cylinder 2.

Before injecting these amounts, the it is preferably checked whether Q5.1 is greater than a second threshold Qmin2 read from a map MAP-Qmin2(fuel pressure, RPM). This map MAP-Qmin2 represents the minimum amounts of fuel that can be injected (as determined e.g. by calibration).

In case Q5.1 is greater than Qmin2, then the injection cycle is carried out with the so-determined amounts, corresponding to the scheme of FIG. 5A.

In case Q5.1 <Qmin2, then it means that Q5.1 is too small to be injected. In such case it is decided to consider skipping injection in c1 and distribute amount Q5 of c1 over the other cylinders, according to the scheme of FIG. 5B.

There, the amount Q5 is split into three equal parts: Q_{R2}=Q5/3. And the amount to be injected in cylinders 3, 4 and 2 is Q5+QR2.

Advantageously, at this point a further test is carried out to check whether the projected fuel amount for second cylinder, c3, is above the forbidden region.

If Q5+QR1>Qmax1, then the injection is carried out as planned by skipping injection at c1 and distributing the corresponding amounts between the remaining three cylinders—as per scheme of FIG. 5B.

However, if Q5+QR2<Qmax1, then the injection on c1 is skipped and the entire amount Q5 is added to the next injection in c3, whereby the fuel amount for cylinder c3 is 2×Q5. The same is done for the next two cylinders: injection skipped for c4; injection of fuel amount 2×Q5 in c2.

It may be noted that although the above process computations are described with respect to fuel amounts, the same can be done with mappings based on PW, since the relationship between PW and Q is known.

1. A method of controlling injection in a hydrogen internal combustion engine comprising a plurality of cylinders, Nc, wherein injection events are performed by applying drive signals to fuel injectors in order to inject predetermined fuel quantities of hydrogen; the method comprising the steps of:
determining a nominal fuel quantity Q_{C,N} to be injected in a cylinder based on torque demand;
determining whether said nominal fuel quantity Q_{C,N} falls within a predetermined forbidden region, FR, of a flow characteristic of the fuel injector; whereby
if the nominal fuel quantity Q_{C,N} does not fall within FR, injecting the nominal fuel quantity Q_{C,N} into the cylinder;
if the nominal fuel quantity Q_{C,N} does fall within FR, then injecting into the cylinder a fraction of the nominal fuel quantity Q_{C,N} that does not fall within FR, or skipping fuel injection in the cylinder, and distributing the remainder of the nominal fuel quantity Q_{C,N} over one or more subsequent injection events in other cylinder(s).

2. The method according to claim 1, wherein said forbidden region is defined as at least one range of fuel amounts.

3. The method according to claim 1, wherein said forbidden region is defined as at least one range of pulse widths.

4. The method according to claim 1, wherein said forbidden region depends on fuel pressure and engine speed.

5. The method according to claim 1, wherein a global fuel amount is determined for injection over all cylinders for one engine cycle to achieve the desired torque, and the nominal fuel quantity Q_{C,N} is computed as the global fuel amount divided by the number of cylinders.

6. The method according to claim 1, wherein the forbidden region FR is determined by calibration and statistically representative for a population of injector.

7. The method according to claim 1, wherein FR is defined by a mapping, which comprises lower range values (Qmin1) and upper range values (Qmax1) in function of fuel pressure and engine speed; and
wherein in case the nominal fuel quantity Q_{C,N} falls within FR, then an export amount Q_{R1} is computed as the difference between the upper value (Qmax1) of FR and Q_{C,N}, and the injectable amount for the cylinder is computed as the difference: Q_{5.1}=Q_{C,N}, −Q_{R1};
whereas the amount injectable for the next cylinder is computed as Q_{C,N}+Q_{R1}.

8. The method according to claim 7, wherein
in case Q_{5.1} is greater than a minimum injection threshold Qmin2 read from a map defining the minimum fuel quantity that can be injected in function of fuel pressure and engine speed, then the amount Q_{5.1} is injected;
in case Q_{5.1} is smaller than the minimum injection threshold Qmin2, the injection in the respective cylinder is skipped and the nominal fuel quantity Q_{C,N} is distributed over one or more of the other cylinders.

9. The method according to claim 8, wherein
in case Q_{5.1}<Qmin2, then an export amount is computed as Q_{R2}=Q_{C,N}/Nc; and
if the amount Q5+Q_{R2} is greater than the upper value of FR, then the injector is controlled to inject the amount Q5+QR2 in the following cylinders;
else, the injection amount is skipped and the next injection event is performed with a fuel amount 2×Q_{C,N}.

10. A fuel injection system comprising a hydrogen fuel line with a plurality of fuel injectors for injection of hydrogen into respective cylinders of an internal combustion engine, and a control unit configured to implement a method as claimed in claim 1.
